(19) United States
(12) Patent Application Publication
(10) Pub. No.: US 2020/0025125 A1
(43) Pub. Date: Jan. 23, 2020

(54) INTERNAL COMBUSTION ENGINE PISTON

(71) Applicant: HITACHI AUTOMOTIVE SYSTEMS, LTD., Hitachinaka-shi, Ibaraki (JP)

(72) Inventors: Toshiyuki FUNAHASHI, Zama-shi, Kanagawa (JP); Hideki ITO, Isehara-shi, Kanagawa (JP); Nobuhiko ISHIBASHI, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/082,229

(22) PCT Filed: Mar. 6, 2017
(86) PCT No.: PCT/JP2017/008747

§ 371 Date: Sep. 4, 2018

(30) Foreign Application Priority Data
Mar. 16, 2016 (JP) 2016-051783

(51) Int. Cl. F02F 3/00; F16J 1/04

(52) U.S. Cl. CPC F02F 3/0084; F02F 2003/0007; F16J 1/04

(57) ABSTRACT

A piston for an internal combustion engine includes: a pair of groove portions which are positioned on the back surface side of the crown portion, and which extend along outer wall surfaces of the apron portions, each of the skirt portions having a width in the circumferential direction of the piston, the width being gradually decreased toward a piston axially lower side which is an axial direction of the piston from the piston crown surface toward the back surface of the crown portion, and each of the groove portions being positioned on an outer side in a radial direction of the piston as the each of the groove portions is positioned on the piston axially lower side, an entire of the each of the groove portions being inclined with respect to a center axis of the piston.

### TECHNICAL FIELD

This invention relates to a piston for an internal combustion engine.

### BACKGROUND ART

For example, a patent document 1 discloses a piston for an internal combustion engine which includes a crown portion defining a combustion chamber; a pair of are skirt portions which are integrally provided to the crown portion, and which are a thrust side that is arranged to be slidably moved on a cylinder wall surface, and an anti-thrust side; and a pair of apron portion each of which is connect both circumferential end portions of the skirt portions, and each of which includes a pin boss portion.

In this patent document 1, a thickness decreasing portion (lightening portion) is formed on the crown portion. The thickness decreasing portion extends along an outer surface of an upper end wall of the apron portion. Portions of the upper end wall of the apron portion between an outside surface of the pin boss portion, and the both circumferential end portions of the skirt portion are constituted by bending portions stepwisely expanding from the outside surface of the pin boss portion toward the both end sides of the skirt portion.

Therefore, the piston of this patent document 1 can attain the weight reduction of the entire of the piston by the thickness decreasing portion of the crown portion. Furthermore, it is possible to decrease the surface pressure of the skirt portion with respect to the cylinder wall surface by the bending portions of the apron portion, and to decrease the friction.

### PRIOR ART DOCUMENT

### Patent Document

Patent Document 1: Japanese Patent Application Publication No. 2015-132248

### SUMMARY OF THE INVENTION

### Problems which the Invention is Intended to Solve

However, the skirt portion of the piston of the above-described patent document 1 has a width in a circumferential direction of the piston. This width is gradually increased toward the piston axially lower side on the piston axially lower side. With this, a drag resistance of the oil is increased between the skirt portion and the cylinder wall surface abutted on the skirt portion. That is, there is still room for improvement on this piston disclosed in the patent document 1, for attaining the weight reduction of the piston and the reduction of the oil drag resistance.

### Means for Solving the Problem

A piston of an internal combustion engine according to the present invention includes a pair of groove portions which are positioned on the back surface side of the crown portion, and which extend along outer wall surfaces of the apron portions, each of the skirt portions having a width in the circumferential direction of the piston, the width being gradually decreased toward a piston axially lower side, and each of the groove portions being positioned on an outer side in a radial direction of the piston as the each of the groove portions is positioned on the piston axially lower side, an entire of the each of the groove portions being inclined with respect to a center axis of the piston.

### Benefit of the Invention

By the present invention, it is possible to suppress the drag resistance of the oil between the skirt portion and the cylinder wall surface while attaining the weight reduction of the piston.

### BRIEF DESCRIPTION OF DRAWINGS

FIG. 1 is a front view of a piston of an internal combustion engine according to the present invention.

FIG. 2 is a side view of the piston of the internal combustion engine according to the present invention.

FIG. 3 is a bottom view of the piston of the internal combustion engine according to the present invention.

FIG. 4 is a perspective view of the piston of the internal combustion engine according to the present invention.

FIG. 5 is a perspective view of the piston of the internal combustion engine according to the present invention.

FIG. 6 is a sectional view taken along a section line A-A of FIG. 1.

FIG. 7 is a sectional view taken along a section line B-B of FIG. 1.

FIG. 8 is a sectional view taken along a section line C-C of FIG. 1.

FIG. 9 is a sectional view taken along a section line D-D of FIG. 1.

FIG. 10 is a side view of a piston of an internal combustion engine according to another embodiment of the present invention.

FIG. 11 is a side view of a piston of an internal combustion engine according to another embodiment of the present invention.

### DESCRIPTION OF EMBODIMENTS

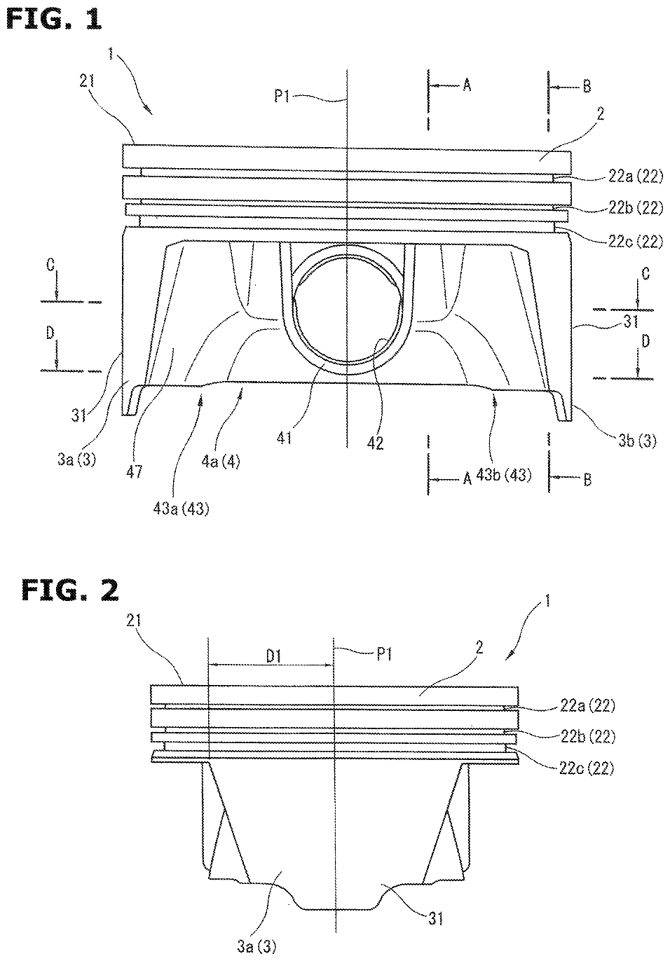

Hereinafter, a piston 1 of an internal combustion engine according to one embodiment of the present invention is explained in detail with reference to FIG. 1 to FIG. 9.

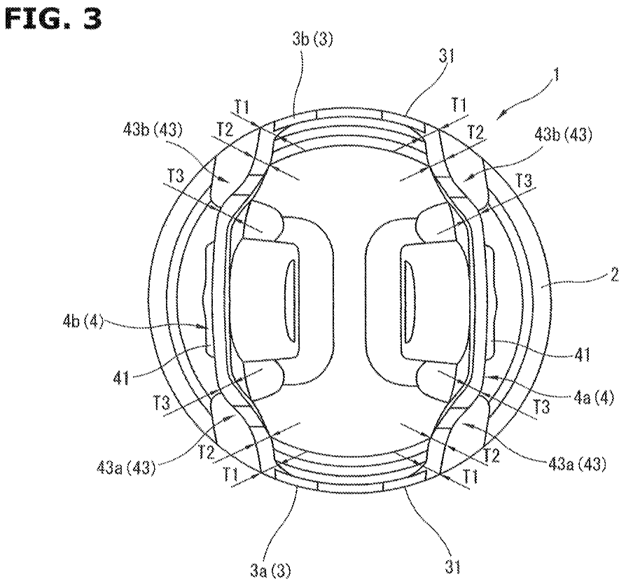

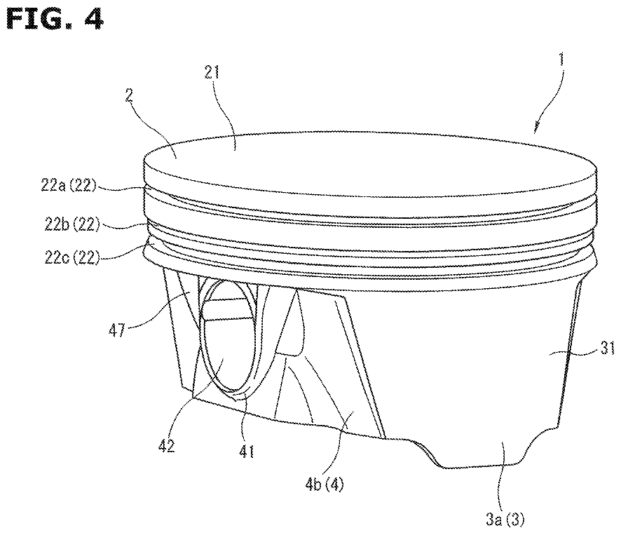

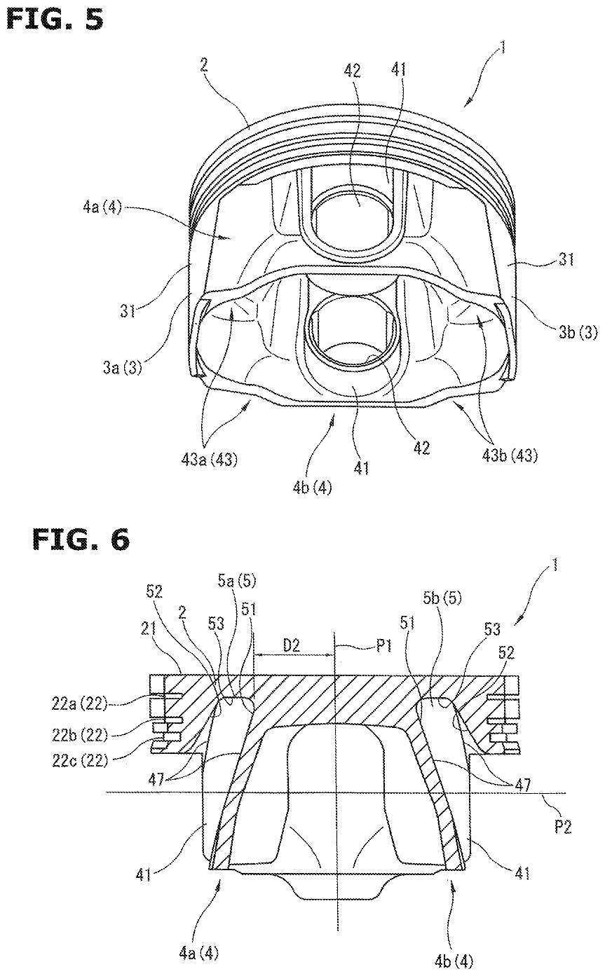

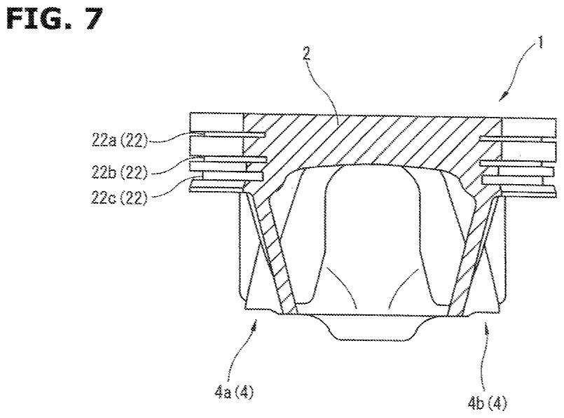

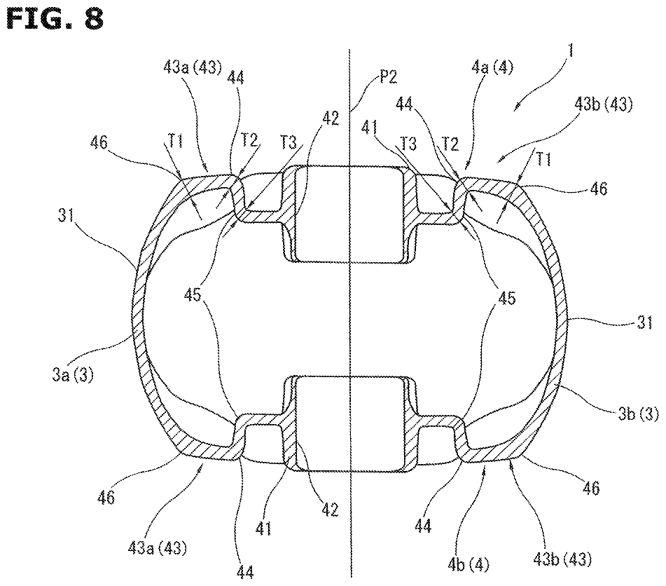

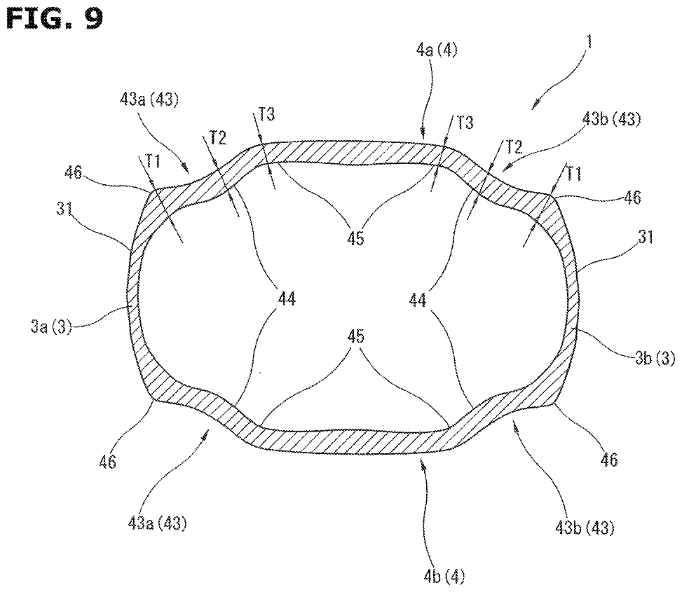

FIG. 1 is a front view of the piston 1. FIG. 2 is a side view of the piston 1. FIG. 3 is a bottom view of the piston 1. FIGS. 4 and 5 are perspective views of the piston 1. FIG. 6 is a sectional view taken along a section line A-A of FIG. 1. FIG. 7 is a sectional view taken along a section line B-B of FIG. 1. FIG. 8 is a sectional view taken along a section line C-C of FIG. 1. FIG. 9 is a sectional view taken along a section line D-D of FIG. 1.

The piston 1 is a casting made from an aluminum alloy. The entire of the piston 1 is integrally formed. This piston 1 is slidably received within a cylinder (not shown) formed in a cylinder block (not shown).

As shown in FIG. 1, FIG. 2, FIG. 6, and FIG. 7, the piston 1 includes a crown portion 2 having a disc shape having a relatively large thickness; a pair of skirt portions 3a and 3b which are a thrust side that is slid with respect to a cylinder wall surface, and an anti-thrust side, and which are integrally provided on a back surface side of the crown portion 2; a pair of apron portions 4a and 4b integrally provided to the back surface side of the crown portion 2; and a pair of groove portions 5a and 5b which are positioned on the back surface side of the crown portion 2, and which extend along outer wall surfaces 47 of the apron portions 4a and 4b.

As shown in FIG. 1, FIG. 2, and FIG. 4 to FIG. 7, the crown portion 2 includes a piston crown surface 21 which is provided on a front surface side, and which constitutes a part of a combustion chamber (not shown) of the internal combustion engine; and three annular ring grooves 22 which are formed on an outer circumference, and in which piston rings (not shown) are mounted. The three ring grooves 22 are a first ring groove 22a which is on a side of the piston crown surface 21, a second ring groove 22b which is on the side of the piston crown surface 21, and a third ring groove 22c which is on a side of the back surface of the crown portion 2. Compression rings (not shown) are mounted, respectively, in the first ring groove 22a and the second ring groove 22b. An oil ring (not shown) is mounted in the third ring groove 22c.

A piston axially lower side is defined by an axial direction of the piston from the piston crown surface 21 toward the back surface of the crown portion 2, that is, a lower side in FIG. 1 and FIG. 2. A piston axially upper side is defined by the axial direction of the piston from the back surface of the crown portion 2 toward the piston crown surface 21, that is, an upper side in FIG. 1 and FIG. 2. The first ring groove 22a is positioned at a piston axially uppermost position in the three ring grooves 22. The third ring groove 22c is positioned at a piston axially lowermost position in the three ring grooves 22.

As shown in FIG. 1, the skirt portions 3a and 3b (thrust side skirt portion 3a and anti-thrust side skirt portion 3b) are disposed at bilateral symmetrical positions (left-right symmetrical positions) with respect to a piston center shaft P1.

The skirt portion 3 is a wall portion whose a substantially entire portion has a relatively small thickness. The entire of the skirt portion 3 is formed into an arc shape.

As shown in FIG. 2 and FIG. 5, the skirt portion 3 has a width which is along a circumferential direction of the piston, and which is gradually decreased toward the piston axially lower side. That is, the skirt portion 3 includes a skirt outer surface 31 which is slidably abutted on the cylinder wall surface, and which has a width that is along the circumferential direction of the piston, and that is gradually decreased toward the piston axially lower side.

Moreover, as shown in FIG. 2 and FIG. 6, the skirt portion 3 includes an end portion which is on the piston axially upper side in a portion connected to the piston 4, and which is positioned on an outer side of the radial direction of the piston with respect to a portion of the groove portion 5 which is positioned on an innermost side of the radial direction of the piston in the end portion of the groove portion 5 that is on the piston axially upper side. That is, the piston 1 is set so that a distance D1 between the piston center axis P1, and the end portion of the skirt portion 3 which is on the piston axially upper side in the portion connected to the apron portion 4 is greater than a distance D2 between the piston center axis P1, and the portion of the groove portion 5 which is the positioned on a piston radially innermost side in the end portion of the piston axially upper side of the groove portion 5.

The apron portions 4a and 4b are disposed on both sides of each of the skirt portions 3a and 3b. That is, the pair of the skirt portions 3a and 3b and the pair of the apron portions 4a and 4b are formed to be continuous in an annular shape along the circumferential direction of the piston.

As shown in FIG. 1, FIG. 3, FIG. 4, FIG. 5, FIG. 8, and FIG. 9, the apron portion 4 includes a pin boss 41 including a pin hole 42 supporting an end portion of a piston pin (not shown); and a pair of bending portion 43a and 43b which are positioned between the pin boss 41 and the skirt portion 3 in the circumferential direction of the piston.

As shown in FIG. 1, the apron portion 4 has an overall width which is along the circumferential direction of the piston, and which is gradually increased toward the piston axially lower side. Furthermore, as shown in FIG. 3, the apron portion 4 is positioned radially inside the outer circumference surface of the crown portion 2 when viewed in the piston axial direction.

The bending portion 43 is a wall portion whose a substantially entire portion has a relatively small thickness. The entire of the bending portion 43 is bent and formed into a crank shape.

The bending portion 43 includes an intermediate bending portion 44 which is provided between the pin boss 41 and the skirt portion 3 in the circumferential direction of the piston; a pin boss side bending portion 45 provided on a side of the pin boss 41 with respect to the intermediate bending portion 44 in the circumferential direction of the piston; and a skirt portion side bending portion 46 which is provided on a side of the skirt portion 3 with respect to the intermediate bending portion 44 in the circumferential direction of the piston.

As shown in FIG. 8 and FIG. 9, the intermediate bending portion 44 has a raised shape which is raised in the radially inward direction of the piston on the piston axially lower side. The intermediate bending portion 44 has a raised shape which is raised in the radially outward direction of the piston on the piston axially upper side.

As shown in FIG. 8 and FIG. 9, the pin boss side bending portion 45 has a raised shape which is raised in the radially outward direction of the piston on the piston axially lower side. The pin boss side bending portion 45 has a raised shape which is raised in the radially inward direction of the piston on the piston axially upper side.

As shown in FIG. 8 and FIG. 9, the skirt portion side bending portion 4 has a raised shape which is raised in the radially outward direction of the piston on the piston axially lower side and the piston axially upper side.

The directions of the raised shapes of the intermediate bending portion 44, the pin boss side bending portion 45, and the skirt portion side bending portion 46 so are set in this way. With this, even at the portion which is raised in the radially inward direction of the piston on the outer circumference side of the bending portion 43, the angle of that portion is not an acute angle. Accordingly, it is possible to relieve the concentration of the stress in the bending portion 43.

A thickness T1 of the skirt portion side bending portion 46 is set to be relatively large. That is, the thickness T1 of the skirt portion side bending portion 46 is set to be larger than thicknesses T2 and T3 of the intermediate bending portion 44 and the pin boss side bending portion 45. Besides, the thickness T1 of the skirt portion side bending portion 46 may be set to be relatively larger than the thickness T2 of the intermediate bending portion 44 or the thickness T3 of the pin boss side bending portion 45.

As shown in FIG. 9, the intermediate bending portion 44 and the pin boss side bending portion 45 are formed so that the thicknesses T2 and T3 are identical to each other on the piston axially lower side. Moreover, the intermediate bending portion 44 and the pin boss side bending portion 45 are formed so that the thicknesses are constant along the axial direction of the piston. By setting the thicknesses of the intermediate bending portion 44 and the pin boss side bending portion 45 in this way, it is possible to improve the fluidity at the casting of the intermediate bending portion 44 and the pin boss side bending portion 45.

The thicknesses of the intermediate bending portion 44 and the pin boss side bending portion 45 may be different from each other.

As shown in FIG. 1, FIG. 4, and FIG. 6, in a region where the pin boss 41 is formed in the circumferential direction of the piston, the outer wall surface 47 of the apron portion 4 is formed to be positioned on the outer side in the radial direction of the piston as the outer wall surface 47 is positioned on the piston axially lower side. That is, the outer surface of the pin boss 41 is inclined to be positioned on the outer side in the radial direction of the piston as the outer surface is positioned on the piston axially lower side.

As shown in FIG. 1, FIG. 4, and FIG. 6, in the region on both sides of the pin boss 41 adjacent to the pin boss 41 in the circumferential direction of the piston, the outer wall surface 47 of the apron portion 4 is formed to be positioned on the outer side in the radial direction of the piston as the outer wall surface 47 is positioned on the piston axially lower side. That is, a portion of the outer wall surface 47 of the apron portion 4 between the pin boss 41 and the pin boss side bending portion 45 in the circumferential direction is inclined to be positioned on the outer side in the radial direction of the piston as the outer wall surface 47 is positioned on the piston axially lower side.

That is, the portion of the outer wall surface 47 of the apron portion 4 on the piston axially upper side includes a portion formed to be positioned on the outer side in the radial direction of the piston as the portion is positioned on the piston axially lower side.

As shown in FIG. 6, each of the groove portions 5a and 5b is a space which is formed on the back surface side of the crown portion 2 by reducing a thickness of the crown portion 2 to have a U-shaped section. Each of the groove portions 5a and 5b is formed on the piston axially upper side in the region in which the pin boss 41 is formed in the piston circumferential direction, and in the region which is on the both sides of the pin boss 41 adjacent to the pin boss 41. That is, the groove portion 5 is formed at the portion of the outer wall surface 47 of the apron portion 4 on the piston axially upper side. The groove portion 5 is formed to be continuous with the portion positioned on the outer side in the radial direction of the piston as the portion is positioned on the piston axially lower side.

The groove portion 5 includes an inside wall surface 51 which is positioned on the inner side in the radial direction of the piston, and which is continuous with the outer wall surface 47 of the apron portion 4; an outside wall surface 52 which is positioned on the outer side in the radial direction of the piston; and a bottom wall surface 53 which is positioned between the inside wall surface 51 and the outside wall surface 52, and which connects the inner wall surface 51 and the outside wall surface 53.

As shown in FIG. 6, the inside wall surface 51 and the outside wall surface 52 are formed to be inclined so that those are positioned on the outer side in the radial direction of the piston as those are positioned on the piston radially lower side, in a section parallel to a plane including the piston center axis P1 and the pin hole axis P2. Moreover, the inclination of the inside wall surface 51 corresponds to an inclination of the outer wall surface 47 of the apron portion 4 which is continuous with the groove portion 5.

That is, as shown in FIG. 6, each of the groove portions 5a and 5b is positioned on the outer side in the radial direction of the piston as the each of the groove portions 5a and 5b is positioned on the piston axially lower side, so that the entire of the each of the groove portions 5a and 5b is inclined with respect to the piston center axis P1.

A mold (cast) for forming the groove portion 5 can be drawn (pulled out) by using the inclination of the outer wall surface 47 of the apron portion 4.

The bottom wall surface 53 is formed so that the position in the axial direction of the piston corresponds to the position of the first ring groove 22a provided on the outer circumference of the crown portion 2. That is, each of the groove portions 5a and 5b is formed so that the end portion on the piston axially upper side is positioned on the inner circumference side of the first ring groove 22a.

As described above, the piston 1 according to this embodiment is formed so that the groove portion 5 is positioned nearer to the center side (the inner circumference side) of the crown portion 2 as the groove portion 5 is positioned nearer to the crown surface side. Accordingly, it is possible to set the groove portion 5 to the large volume, relative to a case where the groove portion is merely formed along the axial direction of the piston. Consequently, it is possible to attain the weight reduction of the piston 1.

Furthermore, the groove portion 5 is formed on the piston axially upper side in the region in which the pin boss 41 is formed in the circumferential direction of the piston, and in the region on the both sides of the pin boss 41 adjacent to the pin boss 41. Accordingly, it is possible to obtain the desired weight reduction of the piston 1.

The skirt portion 3 has a width along the circumferential direction of the piston, more specifically, the width of the skirt outer surface 31 along the circumferential direction of the piston. This width of the skirt portion 3 is gradually decreased toward the piston axially lower side. Accordingly, it is possible to decrease the contact area with respect to the cylinder wall surface, relative to a case where the width of the skirt portion 3 in the circumferential direction of the piston is constant in the axial direction of the piston. Moreover, it is possible to suppress the drag resistance of the oil which is generated between the cylinder wall surface and the skirt portion 3.

Furthermore, the bending portion 43 is provided to the apron portion 4. With this, the bending portion 43 is deformed when the skirt portion 3 is pressed against the cylinder wall surface so as to receive the large load. That is, it is possible to absorb the load in the skirt portion 3 by the deformation of the bending portion 43, and to suppress the excessive increase of the surface pressure of the skirt portion 3.

The thickness of the skirt portion bending portion 46 is set to be relatively large. With this, it is possible to further promote the deformation of the other portion (the bending portion 43) while suppressing the deformation of the skirt portion 3. Accordingly, it is possible to further suppress the increase of the surface pressure of the skirt portion 3.

The load applied to the pin boss 41 becomes greater toward the piston axially lower side. Accordingly, the apron portion 4 is set so that the width in the circumferential direction of the piston is increased toward the piston axially lower side. With this, it is possible to relieve the concentration of the stress in the pin boss 41.

The crown portion 2 receives the pressure acted from the combustion chamber at the portion where the groove portion 5 is provided, by cantilever structure. However, the skirt portion 3 is formed so that the position of the end portion on the piston axially upper side in the portion connected to the apron portion 4 is positioned on the outer side in the radial direction of the piston with respect to the portion positioned on the innermost side in the piston radial direction in the end portion of the groove portion 5 on the piston axially upper side.

Accordingly, in the above-described piston 1 according to the embodiment, the skirt portion 3 supports the portion where the groove portion 5 of the crown portion 2 is provided. Consequently, it is possible to suppress that portion from falling down on the piston axially lower side. That is, it is possible to ensure the rigidity of the crown portion 2 while attaining the weight reduction of the piston 1.

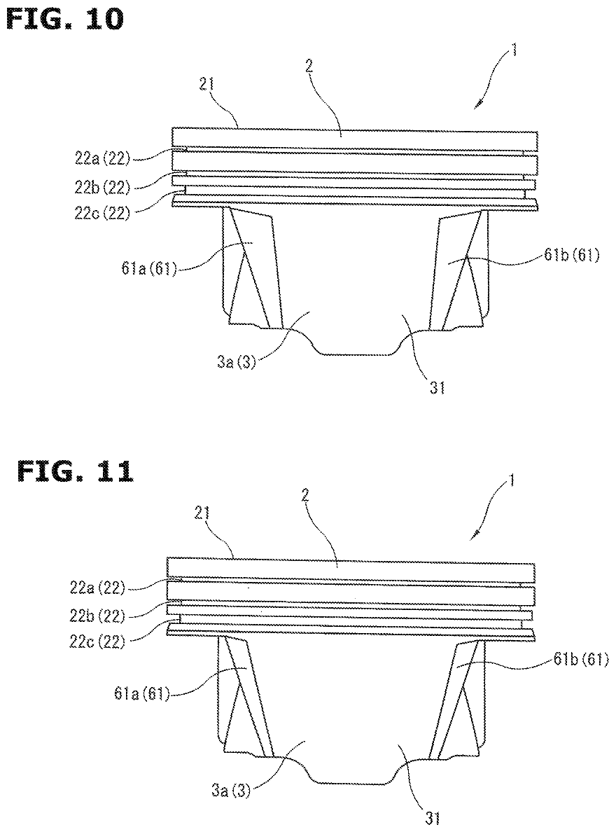

Besides, the skirt portion 3 may include a pair of chamfering portions 61a and 61b positioned on both sides in the circumferential direction of the piston, which are connected to the apron portion 4. The chamfering portions 61a and 61b are positioned on the inner side in the radial direction of the piston with respect to the skirt outer surface. In this case, each of the chamfering portions 61a and 61b has a piston circumferential width which is gradually decreased toward the piston axially lower side. An example shown in FIG. 10 is an example in which the areas of the chamfering portions 61a and 61b have relatively large, relative to the example shown in FIG. 11.

By setting the chamfering portion 61 to the skirt portion 3 in this way, it is possible to save the contact area between the skirt portion 3 and the cylinder wall surface. The chamfering portion 61 can decrease the contact area with the cylinder wall surface on the piston axially upper side of the skirt portion 3. Moreover, it is possible to suppress the drag resistance of the oil between the skirt portion 3 and the cylinder wall.

Following aspects are conceivable as the piston of the internal combustion engine according to the above-described embodiment.

According to one aspect, a piston for an internal combustion engine includes: a crown portion including a piston crown surface which is positioned on a front surface side, and which constitutes a part of a combustion chamber of the internal combustion engine; a pair of skirt portions which are arc shapes, which are integrally provided on a back surface side of the crown portion, and which are a thrust side that is slidably moved with respect to a cylinder wall surface, and an anti-thrust side; a pair of apron portions which are integrally provided on the back surface side of the crown portion, which are disposed on both sides of each of the skirt portions in a circumferential direction of the piston, and which includes a pin boss including a pin hole supporting an end portion of a piston pin; and a pair of groove portions which are positioned on the back surface side of the crown portion, and which extend along outer wall surfaces of the apron portions, each of the skirt portions having a width in the circumferential direction of the piston, the width being gradually decreased toward a piston axially lower side which is an axial direction of the piston from the piston crown surface toward the back surface of the crown portion. Each of the groove portions includes one end portion which is on the piston axially upper side, and which is positioned at a position in the axial direction of the piston. The position of the each of the groove portions corresponds to a position of a piston ring groove provided on the outer circumference of the crown portion. Each of the groove portions is positioned on an outer side in a radial direction of the piston as the each of the groove portions is positioned on the piston axially lower side, an entire of the each of the groove portions being inclined with respect to a center axis of the piston.

The pair of the apron portions and the pair of the skirt portions are formed into an annular shape to be continuous with each other in the circumferential direction of the piston; and each of the apron portions includes a pair of bending portions which are positioned on both sides of the pin boss in the circumferential direction of the piston, and which are connected, respectively, to the pair of the skirt portions.

Each of the bending portions includes an intermediate bending portion which is provided between the pin boss and the skirt portion in the circumferential direction of the piston on the piston axially lower side, and which has a raised shape raised toward an inner side of the radial direction of the piston, a pin boss side bending portion which is provided on a side of the pin boss with respect to the intermediate bending portion in the circumferential direction of the piston on the piston axially am lower side, and which has a raised shape raised toward an outer side of the radial direction of the piston, and a skirt portion side bending portion which is provided on a side of the skirt portion side with respect to the intermediate bending portion in the circumferential direction of the piston on the piston axially lower side, and which has a raised shape raised toward the outer side of the radial direction of the piston; and the skirt portion side bending portion has a thickness greater than a thickness of the intermediate bending portion or the pin boss side bending portion.

The skirt portion side bending portion has the thickness greater than the thicknesses of the intermediate bending portion and the pin boss side bending portion.

The apron portion has a width in the circumferential direction of the piston; and the width of the apron portion is gradually increased toward the piston axially lower side.

Each of the bending portions includes an intermediate bending portion which is provided between the pin boss and the skirt portion in the circumferential direction of the piston, which has a raised shape raised toward an inner side of the radial direction of the piston on the piston axially lower side, and which has a raised shape raised toward an outer side of the radial direction of the piston on a piston axially upper side, a pin boss side bending portion which is provided on a side of the pin boss with respect to the intermediate bending portion in the circumferential direction of the piston, which has a raised shape raised toward the outer side of the radial direction of the piston on the piston axially lower side, and which has a raised shape raised toward the inner side of the radial direction of the piston on the piston axially upper side, and a skirt portion side bending portion which is provided on a side of the skirt portion side with respect to the intermediate bending portion in the circumferential direction of the piston, and which has a raised shape raised toward the outer side of the radial direction of the piston on the piston axially lower side and the piston axially upper side.

The intermediate bending portion and the pin boss side bending portion has an identical thickness on the piston axially lower side. Each of the intermediate bending portion and the pin boss side bending portion may have a constant thickness in the axial direction of the piston.

In a region in which the pin boss is formed in the circumferential direction of the piston, the outer wall surface of the apron portion is positioned on the outer side of the radial direction of the piston as the outer wall surface is positioned on the piston axially lower side.

At portions which are on both sides of the pin boss adjacent to the pin boss in the circumferential direction of the piston, the outer wall surface of the apron portion is positioned on the outer side of the radial direction of the piston as the outer wall surface is positioned on the piston axially lower side.

The skirt portion includes a skirt surface which is slidably abutted on the cylinder wall surface, and which has a width in the circumferential direction of the piston; and the width of the skirt portion is gradually decreased toward the piston axially lower side.

The skirt portion may include both side portions in the circumferential direction of the piston, a pair of chamfering portions which are formed at both side portions as connected to the apron portions, and which are positioned on an inner side in the radial direction of the piston with respect to the skirt surface; and each of the chamfering portion has a width in the circumferential direction of the piston; and the width of the each of the chamfering portion is gradually decreased toward the piston axially lower side.

The skirt portion is formed so that an end portion on the piston axially upper side in the portion connected to the apron portion is positioned on an outer side of the radial direction of the piston with respect to a portion which is on an innermost side of the radial direction of the piston in the end portion of the groove portion on the piston axially upper side.

1. A piston for an internal combustion engine comprising:
a crown portion including a piston crown surface which is positioned on a front surface side, and which constitutes a part of a combustion chamber of the internal combustion engine;
a pair of skirt portions which are arc shapes, which are integrally provided on a back surface side of the crown portion, and which are a thrust side that is slidably moved with respect to a cylinder wall surface, and an anti-thrust side;
a pair of apron portions which are integrally provided on the back surface side of the crown portion, which are disposed on both sides of each of the skirt portions in a circumferential direction of the piston, and which includes a pin boss including a pin hole supporting an end portion of a piston pin; and
a pair of groove portions which are positioned on the back surface side of the crown portion, and which extend along outer wall surfaces of the apron portions,
each of the skirt portions having a width in the circumferential direction of the piston, the width being gradually decreased toward a piston axially lower side which is an axial direction of the piston from the piston crown surface toward the back surface of the crown portion, and
each of the groove portions being positioned on an outer side in a radial direction of the piston as the each of the groove portions is positioned on the piston axially lower side, an entire of the each of the groove portions being inclined with respect to a center axis of the piston.

2. The piston for the internal combustion engine as claimed in claim 1, wherein the pair of the apron portions and the pair of the skirt portions are formed into an annular shape to be continuous with each other in the circumferential direction of the piston; and each of the apron portions includes a pair of bending portions which are positioned on both sides of the pin boss in the circumferential direction of the piston, and which are connected, respectively, to the pair of the skirt portions.

3. The piston for the internal combustion engine as claimed in claim 2, wherein each of the bending portions includes an intermediate bending portion which is provided between the pin boss and the skirt portion in the circumferential direction of the piston on the piston axially lower side, and which has a raised shape raised toward an inner side of the radial direction of the piston, a pin boss side bending portion which is provided on a side of the pin boss with respect to the intermediate bending portion in the circumferential direction of the piston on the piston axially lower side, and which has a raised shape raised toward an outer side of the radial direction of the piston, and a skirt portion side bending portion which is provided on a side of the skirt portion side with respect to the intermediate bending portion in the circumferential direction of the piston on the piston axially lower side, and which has a raised shape raised toward the outer side of the radial direction of the piston; and the skirt portion side bending portion has a thickness greater than a thickness of the intermediate bending portion or the pin boss side bending portion.

4. The piston for the internal combustion engine as claimed in claim 3, wherein the skirt portion side bending portion has the thickness greater than the thicknesses of the intermediate bending portion and the pin boss side bending portion.

5. The piston for the internal combustion engine as claimed in claim 2, wherein the apron portion has a width in the circumferential direction of the piston; and the width of the apron portion is gradually increased toward the piston axially lower side.

6. The piston for the internal combustion engine as claimed in claim 2, wherein each of the bending portions includes
an intermediate bending portion which is provided between the pin boss and the skirt portion in the circumferential direction of the piston, which has a raised shape raised toward an inner side of the radial direction of the piston on the piston axially lower side, and which has a raised shape raised toward an outer side of the radial direction of the piston on a piston axially upper side,
a pin boss side bending portion which is provided on a side of the pin boss with respect to the intermediate bending portion in the circumferential direction of the piston, which has a raised shape raised toward the outer side of the radial direction of the piston on the piston axially lower side, and which has a raised shape raised toward the inner side of the radial direction of the piston on the piston axially upper side, and
a skirt portion side bending portion which is provided on a side of the skirt portion side with respect to the intermediate bending portion in the circumferential direction of the piston, and which has a raised shape raised toward the outer side of the radial direction of the piston on the piston axially lower side and the piston axially upper side.

7. The piston for the internal combustion engine as claimed in claim 6, wherein the intermediate bending portion and the pin boss side bending portion has an identical thickness on the piston axially lower side.

8. The piston for the internal combustion engine as claimed in claim 6, wherein each of the intermediate bending portion and the pin boss side bending portion has a constant thickness in the axial direction of the piston.

9. The piston for the internal combustion engine as claimed in claim 1, wherein in a region in which the pin boss is formed in the circumferential direction of the piston, the outer wall surface of the apron portion is positioned on the outer side of the radial direction of the piston as the outer wall surface is positioned on the piston axially lower side.

10. The piston for the internal combustion engine as claimed in claim 1, wherein at portions which are on both sides of the pin boss adjacent to the pin boss in the circumferential direction of the piston, the outer wall surface of the apron portion is positioned on the outer side of the radial direction of the piston as the outer wall surface is positioned on the piston axially lower side.

11. The piston for the internal combustion engine as claimed in claim 1, wherein the skirt portion includes a skirt surface which is slidably abutted on the cylinder wall surface, and which has a width in the circumferential direction of the piston; and the width of the skirt portion is gradually decreased toward the piston axially lower side.

12. The piston for the internal combustion engine as claimed in claim 11, wherein the skirt portion includes both side portions in the circumferential direction of the piston, a pair of chamfering portions which are formed at both side portions connected to the apron portions, and which are positioned on an inner side in the radial direction of the piston with respect to the skirt surface; and each of chamfering portion has a width in the circumferential direction of the piston; and the width of the each of the chamfering portion is gradually decreased toward the piston axially lower side.

13. The piston for the internal combustion engine as claimed in claim 1, wherein the skirt portion is formed so that an end portion on the piston axially upper side is positioned on an outer side of the radial direction of the piston with respect to a portion which is on an innermost side of the radial direction of the piston in the end portion of the groove portion on the piston axially upper side.
